(19) United States
(12) Patent Application Publication
(10) Pub. No.: US 2016/0305375 A1
(43) Pub. Date: Oct. 20, 2016

(54) FILTER ASSEMBLY

(71) Applicant: Caterpillar Inc., Peoria, IL (US)

(72) Inventor: Timothy S. Finn, Peoria Heights, IL (US)

(73) Assignee: Caterpillar Inc., Peoria, IL (US)

(21) Appl. No.: 14/687,222

(22) Filed: Apr. 15, 2015

(51) Int. Cl. F02M 35/024; B01D 46/00

(52) U.S. Cl. CPC F02M 35/02416; B01D 46/0023; B01D 46/0002

(57) ABSTRACT

A pre-cleaner for a filter assembly having a main filter housing is provided. The pre-cleaner includes a pre-cleaner housing that includes a first wall and a second wall opposite to the first wall. The pre-cleaner is being configured to be detachably coupled to the main filter housing in each of a first configuration and a second configuration. The pre-cleaner also includes a plurality of flow conduits extending between the first wall and the second wall. The plurality of flow conduits is configured to receive a fluid therein in each of the first configuration and the second configuration. The second wall is disposed within the main filter housing in the first configuration and disposed outside the main filter housing in the second configuration.

### TECHNICAL FIELD

The present disclosure relates to a filter assembly, and more specifically to the filter assembly for use in filtering fluids, such as air.

### BACKGROUND

Fluid flow in various machine components, such as an engine may contain entrained particulate material, such as contaminants therein. This particulate material if not removed, may cause substantial damage to components of the engine system. A filter assembly may be provided in association with the engine to remove the particulate material from the fluid flow, for example a flow of air. A variety of the filter assemblies are known for removal of the particulate material from the fluid flow. The filter assemblies generally include a pre-cleaner and a main filter element provided within a housing. In some cases, different sizes of main filter elements are used based on a type of application. For example, the size of the main filter element may depend on its service life.

Conventionally, the housing of the filter assembly is changed to accommodate different sizes for the main filter element. However, the replacement of the housing may affect an overall cost of the filter assembly and thereby an operating cost of the system in which the filter assembly is being employed in.

For reference, U.S Patent Publication No. 2014/0360144 describes an air cleaner and preferred components for an air cleaner. In certain arrangements, a band is permanently mounted to the media pack, surrounding the media. Also, the cartridge is non-circular and includes a radial seal thereon.

### SUMMARY OF THE DISCLOSURE

In one aspect of the present disclosure, a pre-cleaner for a filter assembly having a main filter housing is provided. The pre-cleaner includes a pre-cleaner housing that includes a first wall and a second wall opposite to the first wall. The pre-cleaner is being configured to be detachably coupled to the main filter housing in each of a first configuration and a second configuration. The pre-cleaner also includes a plurality of flow conduits extending between the first wall and the second wall. The plurality of flow conduits is configured to receive a fluid therein in each of the first configuration and the second configuration. The second wall is disposed within the main filter housing in the first configuration and disposed outside the main filter housing in the second configuration.

In another aspect of the present disclosure, a filter assembly is provided. The filter assembly includes a main filter housing having an intake end and a discharge end. The filter assembly also includes a main filter element disposed within the main filter housing. The filter assembly further includes a pre-cleaner that includes a pre-cleaner housing. The pre-cleaner housing includes a first wall and a second wall opposite to the first wall. The pre-cleaner is configured to be detachably coupled to the main filter housing adjacent to the intake end thereof in each of a first configuration and a second configuration. The pre-cleaner also includes a plurality of flow conduits extending between the first wall and the second wall. The plurality of flow conduits is configured to receive a fluid therein in each of the first configuration and the second configuration. The second wall is proximal to the discharge end of the main filter housing in the first configuration and the first wall is proximal to the discharge end of the main filter housing in the second configuration. A first distance between the first wall and the discharge end in the first configuration is less than a second distance between the second wall and the discharge end in the second configuration.

In yet another aspect of the present disclosure, a method of assembling a pre-cleaner having a pre-cleaner housing with a main filter housing of a filter assembly is provided. The method includes detachably coupling a first end of each of a plurality of flow conduits to one of a first wall of the pre-cleaner housing and a second wall of the pre-cleaner housing. The first wall is opposite to the second wall, and the first end of each of the plurality of flow conduits is configured to receive a fluid therein. The method also includes detachably coupling a second end of each of the plurality of flow conduits to another of the first wall and the second wall. The second end of each of the plurality of flow conduits is distal to the first end. The method further includes disposing the second wall of the pre-cleaner housing within the main filter housing when the first end of each of the plurality of flow conduits is detachably coupled to the first wall of the pre-cleaner housing. The method includes disposing the second wall of the pre-cleaner housing outside the main filter housing when the first end of each of the plurality of conduits is detachably coupled to the second wall of the pre-cleaner housing. The method also includes detachably coupling the pre-cleaner housing to the main filter housing.

Other features and aspects of this disclosure will be apparent from the following description and the accompanying drawings.

### BRIEF DESCRIPTION OF THE DRAWINGS

FIG. 1 is a schematic of an exemplary engine system having a filter assembly, according to one embodiment of the present disclosure;

FIG. 2 is a perspective view of the filter assembly having a pre-cleaner in a first configuration, according to one embodiment of the present disclosure;

FIG. 3 is a cut-away view of the filter assembly having the pre-cleaner in the first configuration, according to one embodiment of the present disclosure;

FIG. 4 is an exploded view of the pre-cleaner in the first configuration, according to an embodiment of the present disclosure;

FIG. 5 is a perspective view of the pre-cleaner in the first configuration;

FIG. 6 is a cut-away view of the filter assembly having the pre-cleaner in a second configuration, according to one embodiment of the present disclosure;

FIG. 7 is an exploded view of the pre-cleaner in the second configuration, according to an embodiment of the present disclosure;

FIG. 8 is a perspective view of the pre-cleaner in the second configuration; and

FIG. 9 is a flowchart for a method of assembling the pre-cleaner with the main filter housing of the filter assembly, according to one embodiment of the present disclosure.

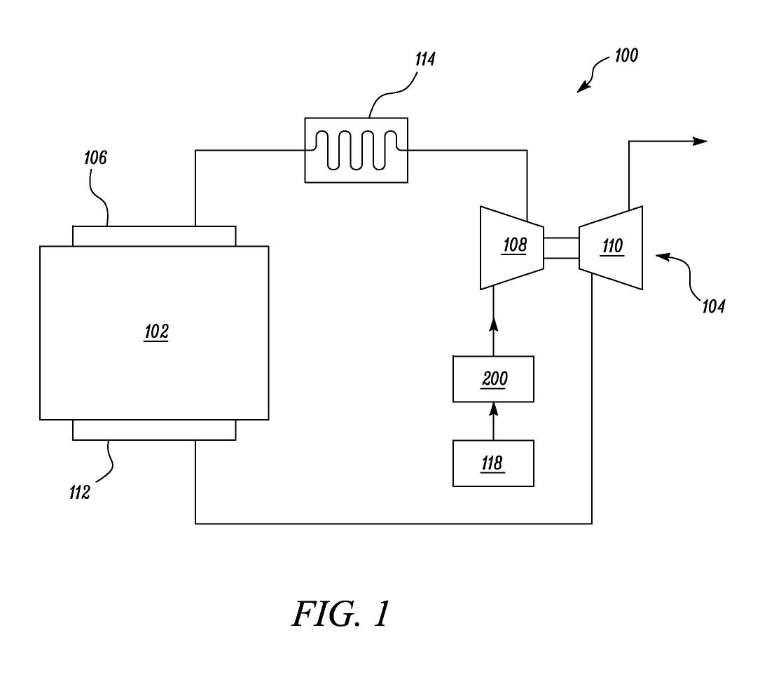

### DETAILED DESCRIPTION

Wherever possible, the same reference numbers will be used throughout the drawings to refer to the same or the like parts. Referring to FIG. 1, an exemplary engine system 100 is illustrated. The engine system 100 includes an engine 102. The engine 102 is embodied as an internal combustion engine powered by diesel fuel. In other embodiments, the engine 102 may be powered by any other fuel, such as gasoline, natural gas, a combination thereof and so on. In an example, the engine 102 may be a gas turbine engine.

The engine system 100 includes a turbocharger 104 provided in fluid communication with the engine 102. The turbocharger 104 is provided upstream of the engine 102 with respect to a flow direction of intake air. Further, the turbocharger 104 is provided in fluid communication with an intake manifold 106 associated with the engine 102. The turbocharger 104 includes a compressor 108 drivably coupled to a turbine 110. The turbine 110 is driven by exhaust gas exiting from an exhaust manifold 112 associated with the engine 102 which in turn drives the compressor 108. The compressor 108 is configured to compress and increase a density of the intake air before being supplied to the intake manifold 106.

Further, the engine system 100 also includes an after-cooler 114, provided downstream of the turbocharger 104. The after-cooler 114 is provided in fluid communication with the compressor 108 and the intake manifold 106. The after-cooler 114 is configured to reduce a temperature of the intake air downstream of the compressor 108 before being supplied to the intake manifold 106. Alternatively, an intercooler (not shown) may be provided within the turbocharger 104, and more specifically, between consecutive stages of compression of the intake air.

It should be noted that the engine system 100 as described herein is exemplary only and hence non-limiting of this disclosure. Moreover, the engine system 100 may embody any other types of systems known in the art.

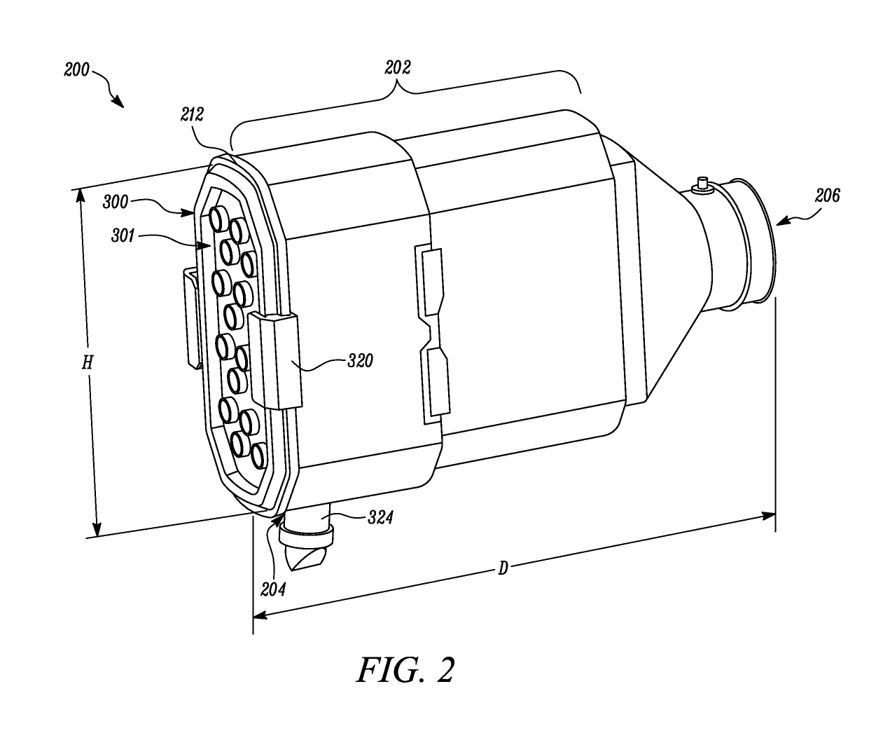

Referring to FIGS. 1 and 2, a filter assembly 200 for the engine system 100 is illustrated. The filter assembly 200 may be configured to filter a fluid flow passing therethrough. In one example, the fluid may be air, such as atmospheric air. In the illustrated embodiment, the filter assembly 200 is in fluid communication with the compressor 108. Further, the filter assembly 200 is also in fluid communication with a source 118 of fluid, for example an air source 118. The filter assembly 200 may receive the air flow from the air source 118. The filter assembly 200 is configured to filter the air passing therethrough and entering into the compressor 108. The filter assembly 200 may separate out abrasive particles, debris or any other particulate contaminants from the air flow. The filter assembly 200 will now be described in detail with reference to the subsequent figures.

The main filter housing 202 defines a volume between the intake end 204 and the discharge end 206. As shown in FIG. 2, the intake end 204 and the discharge end 206 are spaced apart at a distance ‘D’ from each other. Further, the intake end 204 defines a height ‘H’ thereabout.

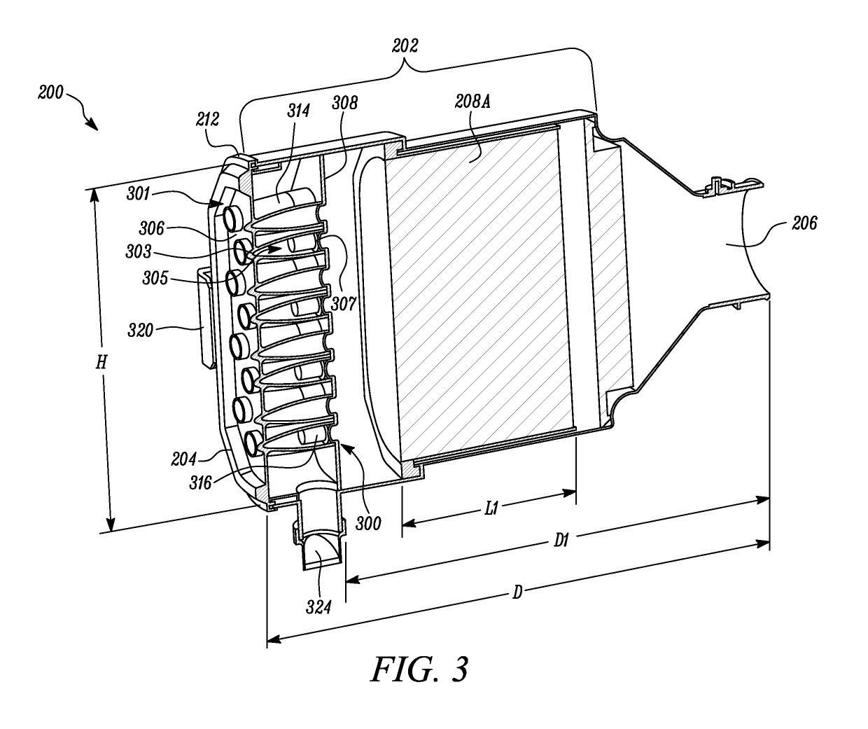

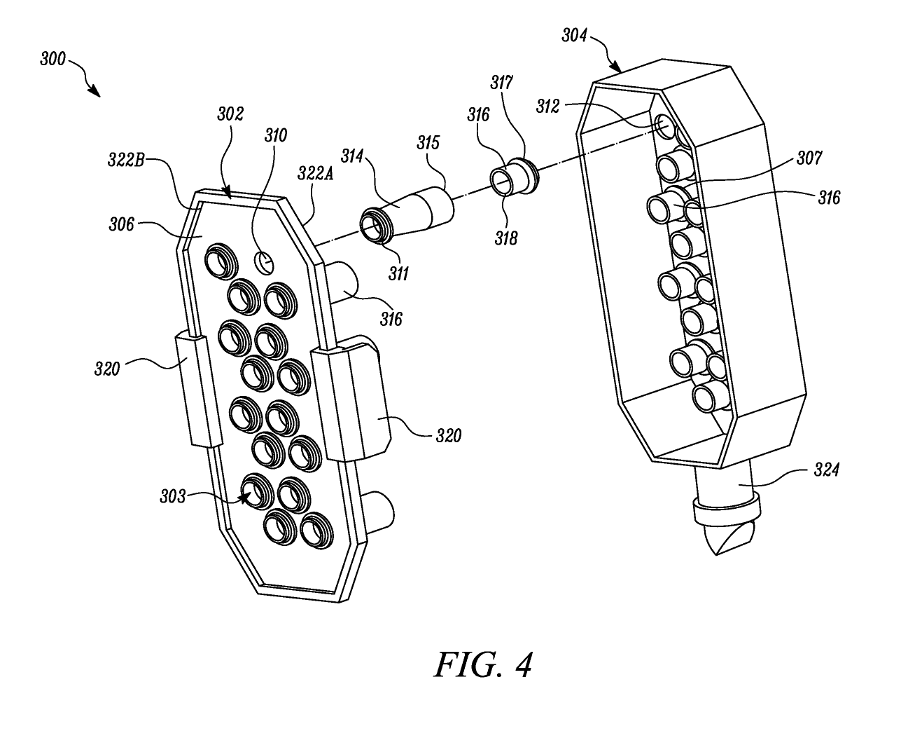

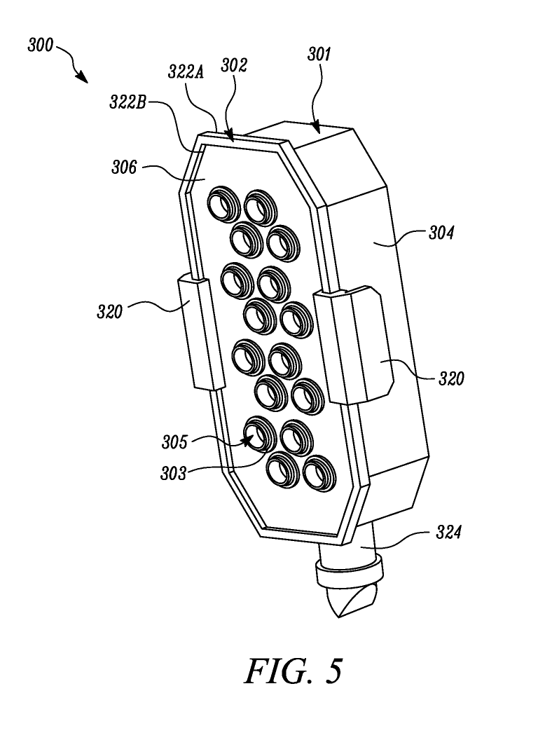

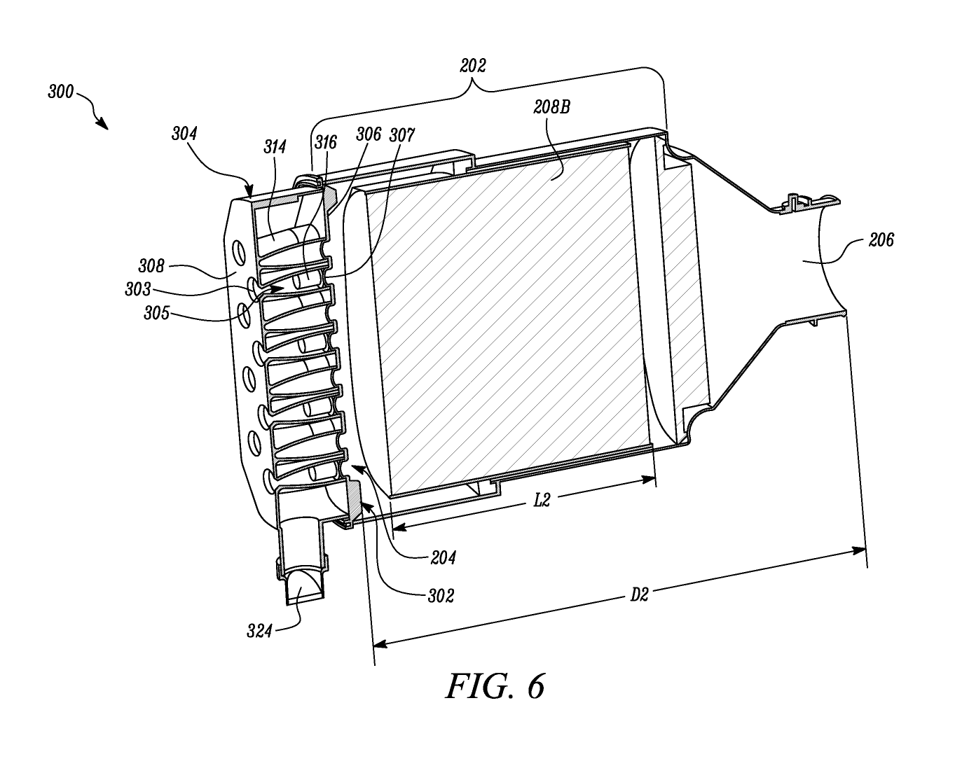

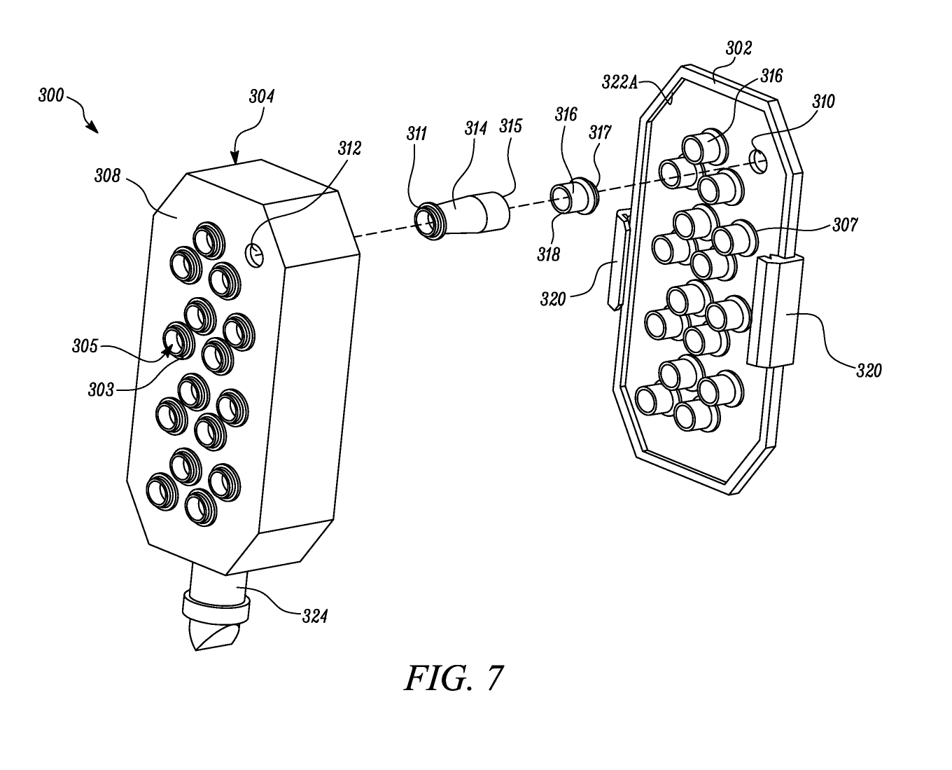

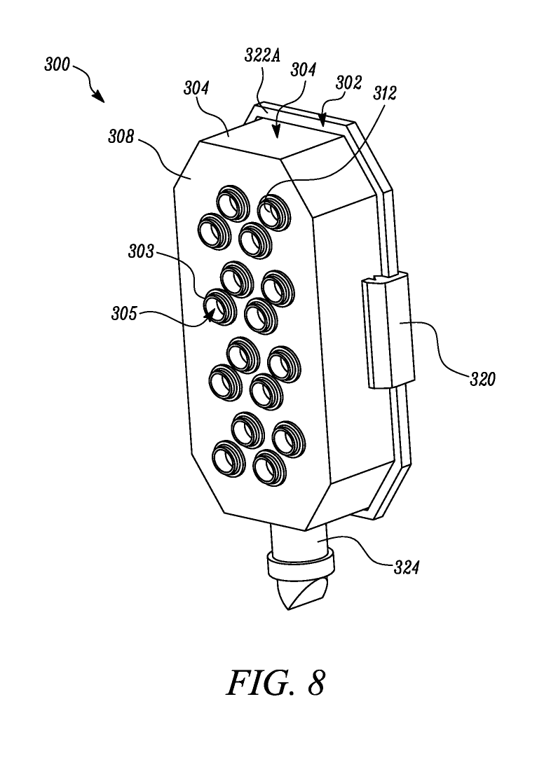

Referring to FIGS. 2 and 3, the filter assembly 200 having a pre-cleaner 300 in a first configuration is illustrated. In FIGS. 4 and 5, the pre-cleaner 300 for the filter assembly 200 in the first configuration is illustrated. Referring to FIG. 6, the filter assembly 200 having the pre-cleaner 300 in a second configuration is illustrated. In FIGS. 7 and 8, the pre-cleaner 300 for the filter assembly 200 in the second configuration is illustrated.

The filter assembly 200 includes a main filter housing 202 in each of the first configuration and the second configuration. The main filter housing 202 has an intake end 204 and a discharge end 206. In an embodiment, the main filter housing 202 may include a lip portion 212 adjacent to the intake end 204.

The filter assembly 200 also includes a main filter element 208A (shown in FIG. 3) disposed in the main filter housing 202, in accordance with one embodiment of the present disclosure. The main filter element 208A has a length ‘L1’. The filter assembly 200 includes a main filter element 208B (shown in FIG. 6) disposed in the main filter housing 202, in accordance with another embodiment of the present disclosure. The main filter element 208B has a length ‘L2’.

The pre-cleaner 300 is configured to filter the particulate matter in the fluid in each of the first configuration and the second configuration that will be described in detail later. Each of the main filter elements 208A, 208B (also collectively referred to as “the main filter element 208”) may further filter the pre-cleaned fluid received from the pre-cleaner 300. Moreover, the main filter element 208 may be configured to further filter relatively smaller contaminants in the fluid. The main filter element 208 may include one or more filter media, such as a paper, a mesh and the like configured to filter the fluid passing therethrough. The filter assembly 200 and the pre-cleaner 300 in each of the first configuration and the second configuration will be described in detail hereinafter.

Referring now to FIGS. 2 to 5, the first configuration of the pre-cleaner 300 and the filter assembly 200 will be described. The pre-cleaner 300 is disposed adjacent to both the main filter element 208A and the intake end 204 of the main filter housing 202. The pre-cleaner 300 includes a pre-cleaner housing 301 configured to be detachably coupled to the main filter housing 202.

The pre-cleaner housing 301 may include a first housing part 302 and a second housing part 304 detachably coupled to the first housing part 302. The first housing part 302 includes a first wall 306. In the illustrated embodiment, the first housing part 302 includes two projecting portions 322A (best shown in FIG. 7), 322B (best shown in FIG. 4) angularly extending in opposite directions to each other from a periphery of the first wall 306. The second housing part 304 includes a second wall 308 opposite to the first wall 306. Further, a free end of the second housing part 304 may be received in a recess defined by the projecting portion 322A. In an embodiment, the second housing part 304 may be coupled to the first housing part 302 by an interference fit. However, it may be contemplated to use other methods to detachably couple the second housing part 304 to the first housing part 302. In an example, the second housing part 304 may be coupled to the first housing part 302 using fasteners.

In the first configuration, the pre-cleaner housing 301 is detachably coupled to the main filter housing 202 adjacent to the intake end 204 thereof. Further, the second wall 308 is disposed proximal to the discharge end 206 whereas the first wall 306 is distal to the discharge end 206. As shown, the second wall 308 and the discharge end 206 defines a first distance ‘D1’ therebetween. In an embodiment, the second wall 308 is disposed within the main filter housing 202.

In the illustrated embodiment, the first housing part 302 includes a pair of attachment portions 320 configured to be detachably coupled with the main filter housing 202. In an example, the attachment portions 320 may be coupled to the main filter housing 202 by a snap fit. Further, the projecting portion 322A of the first wall 306 is configured to be detachably received in the lip portion 212 of the main filter housing 202.

The pre-cleaner housing 301 further includes a plurality of flow conduits 305 extending between the first wall 306 and the second wall 308. The fluid conduits 305 are configured to receive the fluid therein. In the illustrated embodiment, the first wall 306 defines a first plurality of apertures 310 therethrough and the second wall 308 defines a second plurality of apertures 312 therethrough. In an embodiment, a diameter of each of the first apertures 310 and a diameter of each of the second apertures 312 is substantially equal to each other.

In the first configuration, each of the first apertures 310 is configured to receive a first end 303 of each of the flow conduits 305 therein. Further, each of the second apertures 312 is configured to receive a second end 307 of the flow conduits 305 therein.

In the illustrated embodiment of FIG. 4, each of the plurality of flow conduits 305 includes a first tube member 314 and a second tube member 316. The first tube member 314 is configured to be detachably coupled with a corresponding first aperture 310 of the first plurality of apertures 310. The first tube member 314 may define a diameter that is increasing from a first end 311 to a second end 315 thereof. Moreover, the first end 311 of the first tube member 314 may be coupled with the corresponding first aperture 310.

The second tube member 316 includes a first end 317 and a second end 318. The first end 317 of the second tube member 316 is configured to be detachably coupled with a corresponding second aperture 312 of the second plurality of apertures 312 in the first configuration. Further, the second end 318 of the second tube member 316 is configured to be at least partly received within the corresponding first tube member 314. Accordingly, a diameter of the second end 318 of the second tube member 316 may be less than the diameter of the second end 315 of the first tube member 314.

Referring to FIGS. 6 to 8, the pre-cleaner 300 in the second configuration is illustrated. In the illustrated embodiment, the filter assembly 200 includes the main filter element 208B disposed within the main filter housing 202. Moreover, the length ‘L2’ of the main filter element 208B is greater than the ‘L1’ length of the main filter element 208A.

In the second configuration, the pre-cleaner 300 may be disposed such that the first wall 306 is proximal to the discharge end 206 whereas the second wall 308 is distal to the discharge end 206. In an embodiment, the second wall 308 of the pre-cleaner 300 is disposed outside the main filter housing 202. As shown, the pre-cleaner 300 defines a second distance ‘D2’ between the first wall 306 and the discharge end 206. Further, as can be seen from FIGS. 3 and 5, the first distance ‘D1’ is less than the second distance ‘D2’.

The pre-cleaner 300 is detachably coupled to the main filter housing 202 adjacent to the intake end 204. In an embodiment, the projecting portion 322B of the first housing part 302 may be detachably received in the lip portion 212 of the main filter housing 202. Further, the attachment portions 320 may also be configured to be detachably coupled with the main filter housing 202. For example, the attachment portions 320 may be coupled to the main filter housing 202 by a snap fit. In other examples, the pre-cleaner 300 may be detachably coupled with the main filter housing 202 using other suitable methods in each of the first configuration and the second configuration.

In an embodiment, the first end 303 of each of the flow conduits 305 is received in the corresponding second apertures 312 defined in the second wall 308 in the second configuration. Further, the second end 307 of each of the flow conduits 305 is received in the corresponding first apertures 310 defined in the first wall 306.

In the illustrated embodiment, the first tube member 314 is detachably coupled with a corresponding second aperture 312 of the first plurality of apertures 310 in the second configuration. Further, the second tube member 316 is detachably coupled with a corresponding first aperture 310 of the first plurality of apertures 310. Further, the second end 318 of each of the second tube members 316 is at least partly received within the corresponding first tube member 314.

In an embodiment, the coupling of the first and second tube members 314, 316 with the corresponding first and second apertures 310, 312 may be accomplished using an interference fit in each of the first configuration and the second configuration. Additionally or optionally, adhesives may be also be used to couple the first and second tube members 314, 316 with the corresponding first and second apertures 310, 312. Alternatively, other suitable methods, such as welding, mechanical fastening and the like may be used to accomplish the detachable coupling.

Further, each of the flow conduits 305 may include vanes (not shown) in each of the first configuration and the second configuration. In one embodiment, each of the first tube members 314 may include the vanes. In an alternative embodiment, each of the second tube members 316 may include the vanes. The vanes may be configured to apply a centrifugal force on the fluid flowing through the corresponding flow conduit 305 thereby separating the contaminants from the fluid.

The pre-cleaner 300 may generally operate on a principle of centrifugal separation in each of the first configuration and the second configuration. For example, the fluid with its entrained contaminants, enters the pre-cleaner 300 from the source 118 and traverses the vanes which cause the fluid to circulate at a high speed thereby applying the centrifugal force on the fluid. As such, the contaminants, such as debris, moisture and other heavier particles may be separated by the centrifugal force and ejected from the pre-cleaner 300 through a discharge tube 324. The discharge tube 324 may be in fluid communication with a volume defined between the first wall 306 and the second wall 308. In the illustrated embodiment, the second housing part 304 of the pre-cleaner 300 includes the discharge tube 324. Moreover, the fluid that is filtered or pre-cleaned may be allowed to enter the main filter element 208A for further filtration.

Although, the filter assembly 200 is described as being utilized in the engine system 100, a person of ordinary skill in the art will understand that the filter assembly 200 may be utilized in any other suitable applications.

### INDUSTRIAL APPLICABILITY

The present disclosure relates to the pre-cleaner 300 that may be implemented in each of the first configuration and the second configuration. The present disclosure also relates to the filter assembly 200 having the pre-cleaner 300. In an embodiment, main filter elements of different service lives may be used by implementing the pre-cleaner 300 in the first configuration and the second configuration within the same main filter housing 202. The size of the main filter elements may vary with a corresponding service life.

However, the main filter element 208B with a greater length ‘L2’ and thereby a greater service life may be utilized in the filter assembly 200 by implementing the pre-cleaner 300 in the second configuration. Similarly, the main filter element 208A of lesser length ‘L1’ may be used in the filter assembly 200 by implementing the pre-cleaner 300 in the first configuration. Such a filter assembly 200 is cost-effective as the main filter housing 202 need not be changed in each of the first configuration and the second configuration.

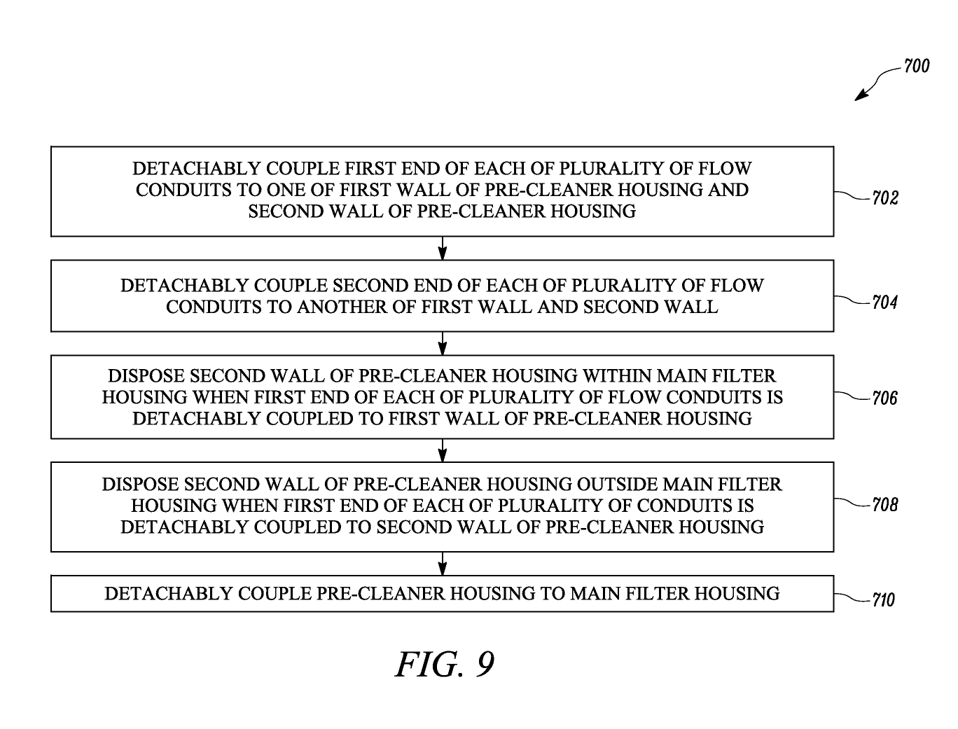

Referring to FIG. 9, a method 700 for assembling the pre-cleaner 300 with the main filter housing 202 of the filter assembly 200 will now be described in detail. At step 702, the method 700 includes detachably coupling the first end 303 of each of the flow conduits 305 to one of the first wall 306 and the second wall 308. In the first configuration, the first end 303 of each of the flow conduits 305 may be detachably coupled to the first wall 306. In the second configuration, the first end 303 of each of the flow conduits 305 may be detachably coupled to the second wall 308.

At step 704, the method 700 includes detachably coupling the second end 307 of each of the flow conduits 305 to the another of the first wall 306 and the second wall 308. In the first configuration, the second end 307 of each of the flow conduits 305 may be detachably coupled to the second wall 308. Alternatively, in the second configuration, the second end 307 of each of the flow conduits 305 may be detachably coupled to the first wall 306.

As described above, the flow conduits 305 may include the first tube member 314 and the second tube member 316. In such a case, the first tube member 314 may be detachably coupled to the corresponding first aperture 310 defined in the first wall 306 in the first configuration at step 702. At step 704, the second tube member 316 may be detachably coupled to the corresponding second aperture 312 defined in the second wall 308 in the first configuration.

Alternatively, the first tube member 314 may be detachably coupled to the corresponding second aperture 312 defined in the second wall 308 in the second configuration at step 702. Further, the second tube member 316 may be detachably coupled to the corresponding first aperture 310 defined in the first wall 306 in the second configuration at step 704.

At step 706, the method 700 includes disposing the second wall 308 of the pre-cleaner housing 301 within the main filter housing 202 when the first end 303 of each of the flow conduits 305 is coupled to the first wall 306 i.e., in the first configuration. Moreover, with such an implementation, the first wall 306 may be proximal to the discharge end 206 and the second wall 308 may be distal to the discharge end 206. Further, the first distance ‘D1’ may be defined between the discharge end 206 and the first wall 306 that is proximal to the discharge end 206 in the first configuration.

At step 708, the method 700 includes disposing the second wall 308 outside the main filter housing 202 when the first end 303 of each of the flow conduits 305 is detachably coupled to the second wall 308 i.e., the second configuration. Moreover, with such an implementation, the second wall 308 may be proximal to the discharge end 206 and the first wall 306 may be distal to the discharge end 206. Further, the second distance ‘D2’ may be defined between the discharge end 206 and the second wall 308 that is proximal to the discharge end 206 in the second configuration. The second distance ‘D2’ is greater than the first distance ‘D1’ thereby providing a larger volume for accommodating the main filter element 208B of greater length ‘L2’.

At step 710, the method 700 includes detachably coupling the pre-cleaner housing 301 to the main filter housing 202. In an embodiment, the projection portion 322A, 322B on the first housing part 302 may be received in the lip portion 212 of the main filter housing 202 in the first configuration and the second configuration respectively. Further, the attachment portions 320 on the first housing part 302 may be detachably coupled to the main filter housing 202 by a snap fit.

An exemplary method of obtaining the second configuration for the filter assembly 200 from the first configuration is described below. The pre-cleaner 300 in the first configuration may be flipped by an angle of 180 degrees. Further, the first tube members 314 may be coupled to the second apertures 312 while the second tube members 316 may be coupled to the first apertures 310. Further, the pre-cleaner 300 may be disposed outside the main filter housing 202. In an embodiment, the pre-cleaner 300 may be detachably coupled to the main filter housing 202 adjacent to the intake end 204 using suitable methods.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A pre-cleaner for a filter assembly having a main filter housing, the pre-cleaner comprising:
a pre-cleaner housing comprising a first wall and a second wall opposite to the first wall, the pre-cleaner being configured to be detachably coupled to the main filter housing in each of a first configuration and a second configuration; and
a plurality of flow conduits extending between the first wall and the second wall, wherein the plurality of flow conduits is configured to receive a fluid therein in each of the first configuration and the second configuration;
wherein the second wall is disposed within the main filter housing in the first configuration, and wherein the second wall is disposed outside the main filter housing in the second configuration.

2. The pre-cleaner of claim 1, wherein the first wall defines a first plurality of apertures therethrough, wherein, in the first configuration, each of the first plurality of apertures is configured to receive a first end of each of the plurality of flow conduits therein, and wherein, in the second configuration, each of the first plurality of apertures is configured to receive a second end of each of the plurality of flow conduits therein, the second end of each of the plurality of flow conduits being distal to the first end.

3. The pre-cleaner of claim 2, wherein the second wall defines a second plurality of apertures therethrough, wherein, in the first configuration, each of the first plurality of apertures is configured to receive the second end of each of the plurality of flow conduits therein, and wherein, in the second configuration, each of the first plurality of apertures is configured to receive the first end of each of the plurality of flow conduits therein.

4. The pre-cleaner of claim 3, wherein each of the plurality of flow conduits comprises:
a first tube member configured to be detachably coupled with a corresponding first aperture of the first plurality of apertures in the first configuration, and wherein the first tube member is further configured to be detachably coupled with a corresponding second aperture of the second plurality of apertures in the second configuration; and
a second tube member configured to be at least partly received within the second tube member, wherein the second tube member is further configured to be detachably coupled with the corresponding second aperture of the second plurality of apertures in the first configuration, and wherein the second tube member is further configured to be detachably coupled with the corresponding first aperture of the first plurality of apertures in the second configuration.

5. The pre-cleaner of claim 1, wherein the pre-cleaner housing comprises:
a first housing part comprising the first wall; and
a second housing part configured to be detachably coupled with the first housing part, the second housing part comprising the second wall.

6. The pre-cleaner of claim 5, wherein the first housing part further comprising a pair of attachment portions configured to be detachably coupled with the main filter housing.

7. The pre-cleaner of claim 1, wherein the first wall further comprises a projecting portion configured to be detachably received in a lip portion of the main filter housing in each of the first configuration and the second configuration.

8. The pre-cleaner of claim 1, wherein the pre-cleaner housing further comprises a discharge tube in fluid communication with a volume defined between the first wall and the second wall.

9. A filter assembly comprising:
a main filter housing having an intake end and a discharge end;
a main filter element disposed within the main filter housing; and
a pre-cleaner comprising:
a pre-cleaner housing comprising a first wall and a second wall opposite to the first wall, the pre-cleaner configured to be detachably coupled to the main filter housing adjacent to the intake end thereof in each of a first configuration and a second configuration; and
a plurality of flow conduits extending between the first wall and the second wall, wherein the plurality of flow conduits is configured to receive a fluid therein in each of the first configuration and the second configuration;
wherein, the second wall is proximal to the discharge end of the main filter housing in the first configuration, wherein the first wall is proximal to the discharge end of the main filter housing in the second configuration, and wherein a first distance between the second wall and the discharge end in the first configuration is less than a second distance between the first wall and the discharge end in the second configuration.

10. The filter assembly of claim 9, wherein the first wall defines a first plurality of apertures therethrough, wherein, in the first configuration, each of the first plurality of apertures is configured to receive a first end of each of the plurality of flow conduits therein, and wherein, in the second configuration, each of the first plurality of apertures is configured to receive a second end of each of the plurality of flow conduits therein, the second end of each of the plurality of flow conduits being distal to the first end.

11. The filter assembly of claim 10, wherein the second wall defines a second plurality of apertures therethrough, wherein, in the first configuration, each of the first plurality of apertures is configured to receive the second end of each of the plurality of flow conduits therein, and wherein, in the second configuration, each of the first plurality of apertures is configured to receive the first end of each of the plurality of flow conduits therein.

12. The filter assembly of claim 11, wherein each of the plurality of flow conduits comprises:
a first tube member configured to be detachably coupled with a corresponding first aperture of the first plurality of apertures in the first configuration, and wherein the first tube member is further configured to be detachably coupled with a corresponding second aperture of the second plurality of apertures in the second configuration; and
a second tube member configured to be at least partly received within the second tube member, wherein the second tube member is further configured to be detachably coupled with the corresponding second aperture of the second plurality of apertures in the first configuration, and wherein the second tube member is further configured to be detachably coupled with the corresponding first aperture of the first plurality of apertures in the second configuration.

13. The filter assembly of claim 9, wherein the pre-cleaner housing comprises:
a first housing part comprising the first wall; and
a second housing part configured to be detachably coupled with the first housing part, the second housing part comprising the second wall.

14. The filter assembly of claim 13, wherein the first housing part further comprise a pair of attachment portions configured to be detachably coupled with the main filter housing.

15. The filter assembly of claim 9, wherein the first wall further comprises a projecting portion configured to be detachably received in a lip portion of the main filter housing in each of the first configuration and the second configuration.

16. The filter assembly of claim 9, wherein the pre-cleaner housing further comprises a discharge tube in fluid communication with a volume defined between the first wall and the second wall.

17. A method of assembling a pre-cleaner with a main filter housing of a filter assembly, the pre-cleaner having a pre-cleaner housing, the method comprising:
detachably coupling a first end of each of a plurality of flow conduits to one of a first wall of the pre-cleaner housing and a second wall of the pre-cleaner housing, wherein the first wall is opposite to the second wall, and wherein the first end of each of the plurality of flow conduits is configured to receive a fluid therein;
detachably coupling a second end of each of the plurality of flow conduits to another of the first wall and the second wall, wherein the second end of each of the plurality of flow conduits is distal to the first end;
disposing the second wall of the pre-cleaner housing within the main filter housing when the first end of each of the plurality of flow conduits is detachably coupled to the first wall of the pre-cleaner housing;
disposing the second wall of the pre-cleaner housing outside the main filter housing when the first end of each of the plurality of conduits is detachably coupled to the second wall of the pre-cleaner housing; and
detachably coupling the pre-cleaner housing to the main filter housing.

18. The method of claim 17, wherein the pre-cleaner housing comprises a first housing part comprising the first wall, and a second housing part comprising the second wall, wherein the method further comprises detachably coupling the second housing part to the first housing part.

19. The method of claim 17, wherein the first wall defines a first plurality of apertures therethrough and the second wall defines a second plurality of apertures therethrough, wherein the method further comprises:
receiving the first end of each of the plurality of flow conduits in one of the first plurality of apertures and the second plurality of apertures; and
receiving the second end of each of the plurality of flow conduits in another of the first plurality of apertures and the second plurality of apertures.

20. The method of claim 19, wherein each of the plurality of flow conduits comprises a first tube member and a second tube member, wherein the method further comprises:
detachably coupling the first tube member with one of a corresponding first aperture of the first plurality of apertures and a corresponding second aperture of the second plurality of apertures;
detachably coupling the second tube member with another of the corresponding first aperture of the first plurality of apertures and the corresponding second aperture of the second plurality of apertures; and
receiving the second tube member at least partly within the first tube member.
